(19) United States
(12) Patent Application Publication
(10) Pub. No.: US 2008/0289912 A1
(43) Pub. Date: Nov. 27, 2008

(54) Sheave for Use in an Elevator System

(76) Inventor: William C. Perron, Burlington, CT (US)

Correspondence Address: CARLSON GASKEY & OLDS, 400 W MAPLE STE 350, BIRMINGHAM, MI, 48009, US

(21) Appl. No.: 12/096,797

(22) PCT Filed: Dec. 28, 2005
(86) PCT No.: PCT/US05/47062

§ 371 Date: Jun. 10, 2008

(51) Int. Cl. B66B 11/00

(52) U.S. Cl. 187/411

(57) ABSTRACT

An elevator system (20) includes idler sheaves (32, 34, 36). A coating on a load bearing member contacting surface (40) of an idler sheave reduces friction between a load bearing member (26) and the contacting surface (40). A disclosed example includes an at least partially metallic coating comprising a fluoropolymer. One disclosed example includes an electroless nickel-polytetrafluoroethylene coating.

### FIELD OF THE INVENTION

This invention generally relates to elevator systems. More particularly, this invention relates to sheaves for use in elevator systems.

### DESCRIPTION OF THE RELATED ART

Elevator systems come in a variety of forms. Some traction-driven elevator systems include a load bearing member such as a rope or belt that supports the weight of an elevator car and a counterweight. A traction sheave propels the load bearing member to cause desired movement of the elevator car. Traditional arrangements rely upon sufficient traction between the traction sheave and the load bearing member to achieve the desired movement and to be able to hold the elevator car in a stationary position by applying a brake to the traction sheave, for example.

Many elevator systems also include one or more idler or deflection sheaves for guiding the load bearing member in a desired pattern. Traditionally, such sheaves have been made from metal. More recently, polymer sheaves have been introduced. Various materials have been used as coatings on idler sheaves to achieve desired characteristics. For example, electroless nickel platings have been used to achieve a desired hardness and to control a profile or contour of the sheave.

In some elevator systems, the interaction between the sheave and the load bearing member tends to introduce undesired noise. One such arrangement includes flat belt load bearing members. A variety of approaches have been proposed for reducing or eliminating such noise. Many of those efforts have focused on modifying the belt.

In some instances, noise results from relative speed differences between belts within a group of belts used as the load bearing assembly. The speed differences occur when there is a difference in sheave diameter between the sheaves guiding corresponding ones of the belts. Additionally, many sheaves have a crown surface which has a varying diameter across a groove or surface upon which the load bearing member rides. These differences in diameter can introduce varying belt speeds between belts or, in some cases, between portions of a belt following the sheave surface.

There is a need for an improved arrangement that is capable of reducing noise associated with interaction between elevator sheaves and load bearing members. This invention addresses that need.

### SUMMARY OF THE INVENTION

An exemplary sheave for use in an elevator system includes a surface adapted for contacting an elevator load bearing member. That surface has an at least partially metallic coating comprising a component that has a friction reducing property. In one example, the component comprises a fluoropolymer. The presence of the fluoropolymer reduces friction between the load bearing member and the sheave surface.

In one example, the coating comprises electroless nickel and polytetrafluoroethylene.

In one example, the coating has a thickness between about 0.025 mm (0.001 inch) and about 0.035 mm (0.0015 inch).

An example method includes coating a sheave with an at least partially metallic coating selected for establishing a desired coefficient of friction between the sheave and a load bearing member.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows selected portions of an elevator system including at least one idler sheave designed according to an embodiment of this invention.

FIG. 2 is a perspective, diagrammatic illustration of an example idler sheave.

### DETAILED DESCRIPTION OF THE PREFERRED EMBODIMENTS

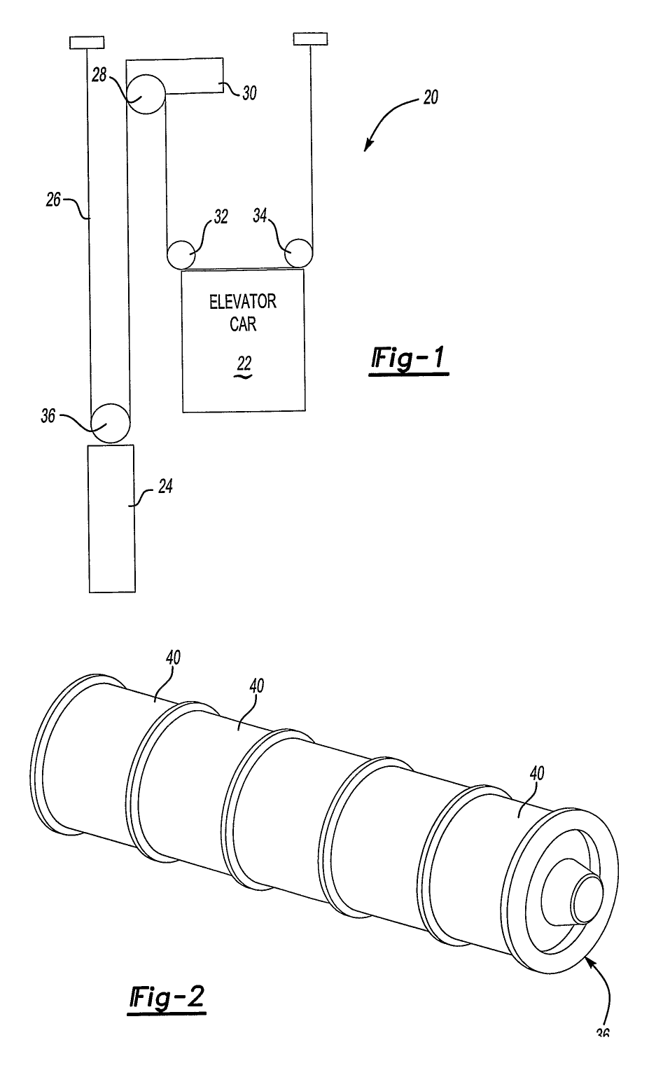

FIG. 1 schematically shows an elevator system 20 including an elevator car 22 and counterweight 24. Load bearing members 26 support the weight of the car 22 and the counterweight 24 in a known manner. In one example, the load bearing members 26 comprises a plurality of flat belts. This invention is not necessarily limited to any particular roping arrangement nor any particular load bearing member configuration.

A traction sheave 28 propels the load bearing members 26 to cause desired movement of the elevator car 22 and counterweight 24 responsive to operation of a machine 30 in a known manner.

The illustrated example includes a plurality of deflector or idler sheaves 32 and 34 associated with the elevator car 22. Another idler sheave 36 is associated with the counterweight 24. As known, idler sheaves guide or direct the load bearing members 26 in a selected pattern or direction as the load bearing members 26 move responsive to movement of the traction sheave 28.

One aspect of the disclosed example is that it introduces a low friction surface on the idler sheaves without introducing the possibility for compromising the necessary friction or traction between the traction sheave 28 and the load bearing member 26. The idler sheaves 32, 34 and 36 essentially guide or direct the load bearing member 26 without requiring traction between those sheaves and the load bearing member to achieve desired elevator system operation.

FIG. 2 shows an example idler sheave 36 that includes a plurality of load bearing member contacting surfaces 40, which are each associated with one of the load bearing members 26. In this example, the load bearing member contacting surfaces 40 generally comprise grooves on the sheave 36. In one example, the load bearing member contacting surfaces 40 are crowned so that the diameter across the surface within each groove varies with a peak near a center of the groove.

The example idler sheave 36 includes a coating on the load bearing member contacting surfaces 40. Selecting the material composition of the coating allows for establishing a desired coefficient of friction between the contacting surface 40 and a corresponding load bearing member 26. One example coating is at least partially metallic and comprises a fluoropolymer. In one example, the coating comprises polytetrafluoroethylene (i.e., Teflon®). Other fluoropolymers such as polyvinylidene difluoride or perfluoroalkoxy are used in other examples. The presence of the fluoropolymer reduces friction between the load bearing members 26 and the surfaces 40 on the sheave 36 in some examples. Reducing friction reduces or eliminates relative speed differences between individual load bearing members 26 (e.g., belts), which has the advantage of reducing noise in the elevator system 20.

In situations where the load bearing member contacting surfaces 40 are crowned and the load bearing members comprise flat belts, the coating on the surface 40 can reduce relative speed differences between portions of the belt, which might otherwise occur because of the differences in sheave diameter across the portion of the surface 40 contacting the load bearing member.

Reducing friction between the idler sheave load bearing member contacting surfaces 40 and the load bearing members 26 makes it more possible for the load bearing members to slide across the surface of the idler sheave. In some examples, this reduces noise that might otherwise occur because of relative speed differences between load bearing members interacting with the sheaves or relative speed differences between portions of a belt.

One particular example coating comprises a commercially available electroless nickel-Teflon plating. Known electroless plating techniques are used to apply the coating to each surface 40 in one example. Prior to this invention, an electroless nickel plating was only used to control the contour on the sheave. With this invention, material selection allows for (or is based upon a desire for) establishing a desired coefficient of friction between an idler sheave and a load bearing member. One example includes selecting a metallic coating. Another example includes selecting a coating that includes at least one component that has a friction reducing property. Example components of this type include fluoropolymers.

One example includes a coating having a thickness in a range from about 0.020 mm to about 0.050 mm. One example includes a coating thickness in a range between about 0.025 mm (0.001 inch) and about 0.035 mm (0.0015 inch). Controlling the thickness of the coating allows for controlling the exterior geometry of the sheave load bearing member contacting surface 40 in a manner that will not introduce a potential for noise. In other words, one example includes controlling the thickness of the coating to avoid distorting the surface 40 on the idler sheave away from the intended design of the sheave contacting surface 40.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-20. (canceled)

21. An elevator sheave, comprising:
a sheave surface adapted for contacting an elevator load bearing member and having an at least partially metallic coating on the sheave surface comprising a component having a friction reducing property, the coating comprising electroless nickel.

22. The elevator sheave of claim 21, wherein the coating comprises a fluoropolymer.

23. The elevator sheave of claim 22, wherein the coating comprises polytetrafluoroethylene.

24. The elevator sheave of claim 21, wherein the coating has a thickness in a range from about 0.020 mm to about 0.050 mm.

25. The elevator sheave of claim 24, wherein the thickness is in a range from about 0.025 mm (0.001 inch) to about 0.038 mm (0.0015 inch).

26. An elevator system, comprising:
a load bearing member adapted to support at least a load associated with an elevator car;
a traction sheave for frictionally engaging the load bearing member to cause a desired movement of the load bearing member; and
an idler sheave for guiding movement of the load bearing member, the idler sheave having an at least partially metallic coating on a surface that contacts the load bearing member, the coating comprises a component having a friction reducing property, the coating comprising electroless nickel.

27. The elevator system of claim 26, wherein the coating comprises a fluoropolymer.

28. The elevator system of claim 27, wherein the coating comprises polytetrafluoroethylene.

29. The elevator system of claim 26, wherein the coating has a thickness in a range from about 0.020 mm to about 0.050 mm.

30. The elevator system of claim 29, wherein the thickness is in a range from about 0.025 mm (0.001 inch) to about 0.038 mm (0.0015 inch).

31. A method of making a sheave for use in an elevator system, comprising:
selecting a coating for a load bearing member contacting surface on the sheave to establish a desired coefficient of friction between the contacting surface and a corresponding load bearing member, the coating comprising electroless nickel.

32. The method of claim 31, wherein the coating comprises a fluoropolymer.

33. The method of claim 32, wherein the coating comprises polytetrafluoroethylene.

34. The method of claim 31, comprising applying the coating to establish a thickness of the coating in a range from about 0.020 mm to about 0.050 mm.

35. The method of claim 34, comprising applying the coating to establish the thickness in a range from about 0.025 mm (0.001 inch) to about 0.038 mm (0.0015 inch).
